(19) United States
(12) Patent Application Publication
(10) Pub. No.: US 2014/0246532 A1
(43) Pub. Date: Sep. 4, 2014

(54) ENDLESS WIRE CONTAINER AND METHOD OF USING SAME

(71) Applicant: LINCOLN GLOBAL, INC., City of Industry, CA (US)

(72) Inventors: Michael A. Carroscia, Newbury, OH (US); Dennis K. Hartman, North Ridgeville, OH (US)

(73) Assignee: LINCOLN GLOBAL, INC., City of Industry, CA (US)

(21) Appl. No.: 14/275,180

(22) Filed: May 12, 2014

Related U.S. Application Data
(63) Continuation of application No. 11/121,489, filed on May 3, 2005, now abandoned.

(51) Int. Cl. B23K 9/133; B65H 49/12

(52) U.S. Cl. CPC B23K 9/1333; B65H 49/12
USPC 242/171

(57) ABSTRACT

A container for packaging and unwinding a coil of welding wire to allow an uninterrupted flow of the welding wire from one the container to another the container. The coil of welding wire including a coiled portion having a top and a bottom, a first extension of the wire extending from the coil near the coil top to a feeding end and a second extension of the wire extending from the coil near the bottom to a transfer end. The transfer end of the one container being joinable to the feeding end of the another container. The container including an outer packaging with at least one vertically extending side wall, a closed bottom, a top opening for removing the welding wire and a wire coil receiving cavity within the outer packaging for receiving the wire coil. The feeding end and the transfer end being positionable near the top opening; the container further including a transfer sleeve having a first end, a second end and a wire passage extending along a sleeve axis longitudinally between the first and second ends, the wire passage being sized to allow the welding wire to travel axially through the passage. The sleeve further including a separable release slot extending between the first and second ends and the slot having a substantially closed position to maintain the welding wire in the passage. The slot also including a separated position to allow a length of the wire in the passage to pass transversely through the slot.

### CONTINUING APPLICATION DATA

This U.S. patent application claims priority to and is a continuation patent application of U.S. patent application Ser. No. 11/121,489 filed on May 3, 2005, which is incorporated herein by reference in its entirety.

### TECHNICAL FIELD

The present invention relates to welding wire packaging and more particularly to welding wire package for use as an endless wire container such that the welding wire of multiple containers can be linked together to produce an uninterrupted flow of welding wire to a welding operation.

### INCORPORATION BY REFERENCE

Welding wire used in high production operations, such as robotic welding stations, is provided in a large package having over 200 pounds of wire. The welding wire, in these packages, is looped into convolutions of wire loops forming a wire coil extending around a central core or a central clearance bore. One such winding technique is shown in Cooper U.S. Pat. No. 6,019,303 which discloses a method and apparatus for packing wire in a storage drum and which is incorporated by reference herein as background material showing the same.

However, even the use of large packaging does not eliminate down-time for the welding operation when the welding wire of the packaging or container is exhausted. Even if a new container of welding wire is staged for a quick change-over; the welding wire from the new container must be threaded through the feeding apparatuses and to the welding torch. As can appreciated, this can cause significant down time especially for welding operations that consume a large quantity of welding wire. Accordingly, it has been proposed to butt welding the trailing end of the welding wire from one container to the leading end of the welding wire from another container. However, it has been found that an e-script condition is created in the welding wire when the transfer from an exhausted container to the next full container takes place. Jensen 2004/0155090 discloses such an endless wire arrangement and is incorporated by reference herein as background material showing the same.

As can be appreciated, any apparatus and/or arrangement that is used for endless wire containers needs to function with other components of the welding wire container such that an uninterrupted flow of welding wire to the welding operation is achieved. To control the transportation and payout of the wire, an upper retainer or braking device, such as a braking ring, can be used to help control the unwinding of the wire from the wire coil. One such package is shown in Cooper U.S. Pat. No. 5,819,934 which discloses a welding wire drum that utilizes a braking ring to control the unwinding of the welding wire from the wire coil. Cooper U.S. Pat. No. 5,819,934 is also incorporated by reference herein as background material showing the same. Another such packaging is shown in Chung U.S. Pat. No. 5,746,380 which also discloses a welding wire drum, however, Chung discloses a different wire flow controlling apparatus for controlling the payout of the welding wire from the drum. Chung is also incorporated by reference herein for showing the same.

### BACKGROUND OF INVENTION

In the welding industry, tremendous numbers of robotic welding stations are operable to draw welding wire from a package as a continuous supply of wire to perform successive welding operations. The advent of this mass use of electric welding wire has created a need for large packages for containing and dispensing large quantities of welding wire. However, as can be appreciated, there is a limit to the size of the welding wire package. If the package or containers are too large, they become difficult to transport, are very costly which can be a factor if the container is damaged, and the containers consume a large portion of floor space near the welding operation. As a result, even when large containers of welding wire are utilized, down time is inevitable when the wire is exhausted from the container. While quick change over techniques can be utilized to replace the exhausted container with a new container of welding wire, the welding' operation is shut down. In view of the new high tech and costly robotic welding systems, a short down time can be very costly. This is especially true in multiple robotic welding production lines that utilize several robotic welding operations. As can be appreciated, a single off line robotic welder can result in several robotic welding systems being forced offline.

In order to reduce down time, attempts have been made to link the welding wire from one container to the welding wire of another container. The theory being that if welding wire containers can be joined to one another, an “endless wire” welding wire supply can be produced wherein a welding operation is never shut down due to an exhausted wire container. While the theory is sound, the practicality of achieving an endless wire without tangling the welding wire is a different matter. As can be appreciated, a tangled welding wire can be a worse condition than an exhausted container of welding wire and can create greater amounts of down time. Accordingly, in order to achieve an endless wire container, tangling needs to be eliminated or at least a rare occurrence.

A large capacity welding wire container typically includes an outer container, such as a drum, with welding wire looped about a central, vertical axis to form a wire coil. The coil has atop surface with an outer cylindrical surface that is supported by the outer packaging and an inner cylindrical surface defining a central bore coaxial to the central, vertical axis. The central bore can be occupied by a cardboard, cylindrical core, as is shown in Cooper U.S. Pat. No. 5,819,934.

Jensen discloses an endless wire arrangement used in connection with octagonal welding wire containers. With reference to FIGS. 1C and 1D, Jensen further discusses what this application will refer to as an e-script condition that results when the welding wire from one container is joined to the welding wire of another container. As is stated above, the welding wire is wound into the container such that it extends about a vertically extending central axis. Further, the winding process can be used to produce a natural cast in the wire creating upward spring forces in the coil and an outward force in the coil. As the wire is exhausted in the one container, the last remaining loop rises in the container and folds over itself to produce the e-script tangle. As can be appreciated, the e-script tangle forces the operation to be shut down so that the e-script can be removed.

Jensen attempts to overcome the e-script problem with a large bulbous runner 11. The runner is configured to interfere with the formation of the e-script by being positionable at the formation point of the e-script. However, the runner disclosed in Jensen has many flaws. First, as is shown in FIG. 2, runner 11 is shaped and sized such that it can fall below the retainer ring Ref: 4 whereby the runner can be become lodged below the retainer ring. Further, the weight of the runner can negatively produce significant downward force in the welding wire when the first container is exhausted. This is' especially important since the runner disclosed in Jensen has a central passage configuration that prevents the runner from being removed from the welding wire without cutting the welding wire or destroying the runner For these reasons and other reasons, the Jensen device fails to effectively overcome the problems with creating an endless wire system.

In order to work in connection with the wire feeder of the welder, the welding wire must be dispensed in a non-twisted, non-distorted and non-canted condition which produces a more uniform weld without human attention. It is well known that wire has a tendency to seek a predetermined natural condition which can adversely affect the welding process. Accordingly, the wire must be sufficiently controlled by the interaction between the welding wire package and the wire feeder. To help in this respect, the manufacturers of welding wire produce a wire having natural cast, wherein, if a segment of the wire was laid on the floor, the natural shape of the wire would be essentially a straight line; however, in order to package large quantities of the wire, the wire is coiled into the package which can produce a significant amount of wire distortion and tangling as the wire is dispensed from the package. As a result, it is important to control the payout of the wire from the package in order to reduce twisting, tangling or canting of the welding wire. This condition is worsened with larger welding wire packages which are favored in automated or semi-automated welding.

The payout portion of the welding wire package helps control the outflow of the welding wire from the package without introducing additional distortions in the welding wire to ensure the desired continuous smooth flow of welding wire. Both tangling or breaking of the welding wire can cause significant down time” while the damaged wire is removed and the wire is re-fed into the wire feeder. In this respect, when the welding wire is payed out of the welding wire package, it is important that the memory or natural cast of the wire is controlled so that the wire does not tangle. The memory or natural cast of the wire causes a constant force in the convolutions of wire which is directed outwardly such that the diameter of the convolutions is under the influence of force to widen. The walls of the wire welding package prevent such widening. However, when the welding wire is paid out of the package, the walls of the package lose their influence on the wire and the wire will move toward its natural cast. This causes the portion of the wire which is being withdrawn from the package to loosen and tend to spring back into the package thereby interfering and possibly becoming tangled with other convolutions of wire. In addition to the natural cast, the wire can have a certain amount of twist which causes the convolutions of welding wire in the coil to spring upwardly.

The payout device, braking devices or retainer ring is positioned on the top of the coil and is forced downwardly against the natural springing effect of the welding wire. The downward force is either the result of the weight of the retainer ring or a separate force producing member such as an elastic band connected between the retainer ring and the bottom of the package. The wire is directed through the retainer ring in a designated manner to control its outward flow. With respect to the downward force, of the ring, the optimal downward force during the shipment of the package is different than the optimal downward force for the payout of the welding wire. Accordingly, while elastic bands or other straps are utilized to maintain the position of the payout or retainer ring during shipping, the weight of the retainer ring can be used to maintain the position of the payout relative to the wire coils during the payout or the wire. However, the braking device must descend within the package as the wire in unwound from the wire coil.

As can be appreciated, it is preferred that any device utilized to transform a welding wire container into an endless wire system should be capable of functioning with existing welding wire technology and new welding wire technology. In this respect, and is as discussed above, braking devices or rings are utilized to control the unwinding of the wire from the wire coil. It is important that the wire be controlled to minimize tangling or any other form of interruption of flow of the welding wire. These braking devices have evolved over the years and devices such as is disclosed in Cooper have been found to be effective. Therefore, the ability to utilize existing brake ring technology is an advantage.

The welding wire can also be controlled by other mechanisms such as the packaged beads as is shown in Chung. The packaged beads along with pressing pipes help control the out flowing welding wire as it exits the wire drum. Again, endless wire systems configured to work with existing technologies that have been proven to provide tangle free wire dispensing is an advantage.

### STATEMENT OF INVENTION

In accordance with the present invention, provided is a container for packaging and unwinding a coil of welding wire to allow an uninterrupted flow of the welding wire from one container to another container.

More particularly, the container houses a coil of welding wire including a coiled portion having a top and a bottom, a first extension of the wire extending from the coil near the coil top to a feeding end and a second extension of the wire extending from the coil near the coil bottom to a transfer end. The transfer end of the one container being joinable to the feeding end of another container. The container can include an outer packaging with at least one vertically extending side wall, a closed bottom, a top opening for removing the welding wire and a wire coil receiving cavity within the outer packaging for receiving the wire coil. The feeding end and the transfer end are positionable near the top opening to allow easy access to both.

The container further includes a transfer sleeve having a first end, a second end and a wire passage extending along a sleeve axis longitudinally between the first and second ends. The wire passage being sized to allow the welding wire to travel axially through the passage. The sleeve further includes a separable release slot extending between the first and second ends; the slot having a substantially closed position to maintain the welding wire in the passage and a separated position to allow a length of the wire in the passage to pass transversely through the slot.

According to another aspect of the present invention, provided is a sleeve for a container for packaging and unwinding a coil of welding wire to allow an uninterrupted flow of the welding wire from one the container to the other container. The sleeve includes a first end, a second end and a wire passage extending along a sleeve axis longitudinally between the first and second ends. The sleeve axis and the sleeve can be arcuate and the wire passage being sized to allow the welding wire to travel axially through the passage. The sleeve further including a separable release slot extending between the first and second ends wherein the slot has a substantially closed position to maintain the welding wire in the passage and a separated position to allow a length of the wire in the passage to pass transversely through the slot.

### BRIEF DESCRIPTION OF DRAWINGS

The foregoing, and more, will in part be obvious and in part be pointed out more fully hereinafter in conjunction with a written description of preferred embodiments of the present invention illustrated in the accompanying drawings in which:

FIG. 1 is a partially sectioned top, side perspective view of a first and a second container according to the present invention which are joined to one another and are both in a full condition;

FIG. 2 is a partially sectioned top, side perspective view of the two containers shown in FIG. 1 wherein one container is in an exhausted condition;

FIG. 3 is a top, side perspective view of the containers shown in FIG. 1 wherein the change over to the second container is complete;

FIG. 4 is an enlarged, partially sectioned view of a sleeve according to the present invention;

FIG. 5 is a sectional view taken from line 5-5 in FIG. 4;

FIG. 6A is an enlarged view of the welding wire and the sleeve in a first position during the transfer from one container to the other;

FIG. 6B is an enlarged view of the welding wire and the sleeve in a second position during the transfer from one container to the other;

FIG. 6C is an enlarged view of the welding wire and the sleeve in a third position during the transfer from one container to the other;

FIG. 6D is an enlarged view of the welding wire and the sleeve in a fourth position during the transfer from one container to the other;

FIG. 7 is an enlarged perspective view of yet another embodiment with a sleeve having a sine wave slot;

FIG. 8 is an enlarged perspective view of a further embodiment with a sleeve having a spiral slot;

FIG. 9 is an enlarged perspective view of still yet a further embodiment including finger tabs;

FIG. 10 is an enlarged perspective view of a sleeve showing yet another embodiment including a finger tab;

FIG. 11 is an enlarged, semi-sectional view, of a full container after the wire has been transferred from an exhausted container;

FIG. 12 is a side sectional view of the containers shown in FIG. 1 with some wire removed from one container; shown in FIG. 1 wherein the majority of the welding wire has been removed from one of the containers;

FIG. 13 is a partially sectioned, top plan view of the containers shown in FIG. 1;

FIG. 14 is a side elevational view; partially sectioned, of the containers;

FIG. 15 is a side elevational view, partially sectioned, of the containers shown in FIG. 1 at the beginning of the transferring step; and,

FIG. 15A is an enlarged, partially sectional view of the sleeve positioned over a retaining ring.

### DESCRIPTION OF PREFERRED EMBODIMENTS

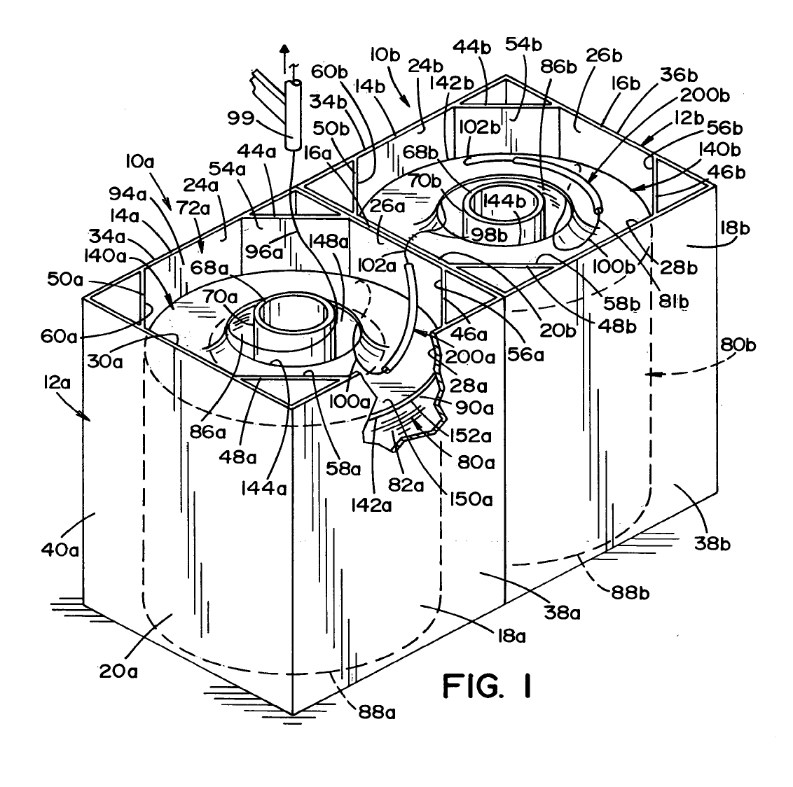

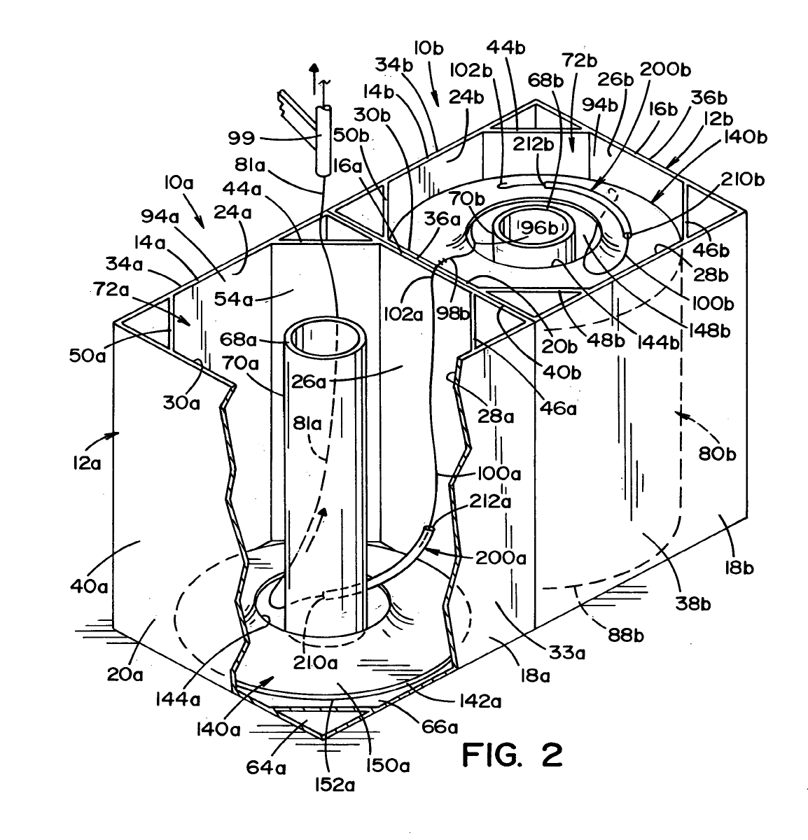

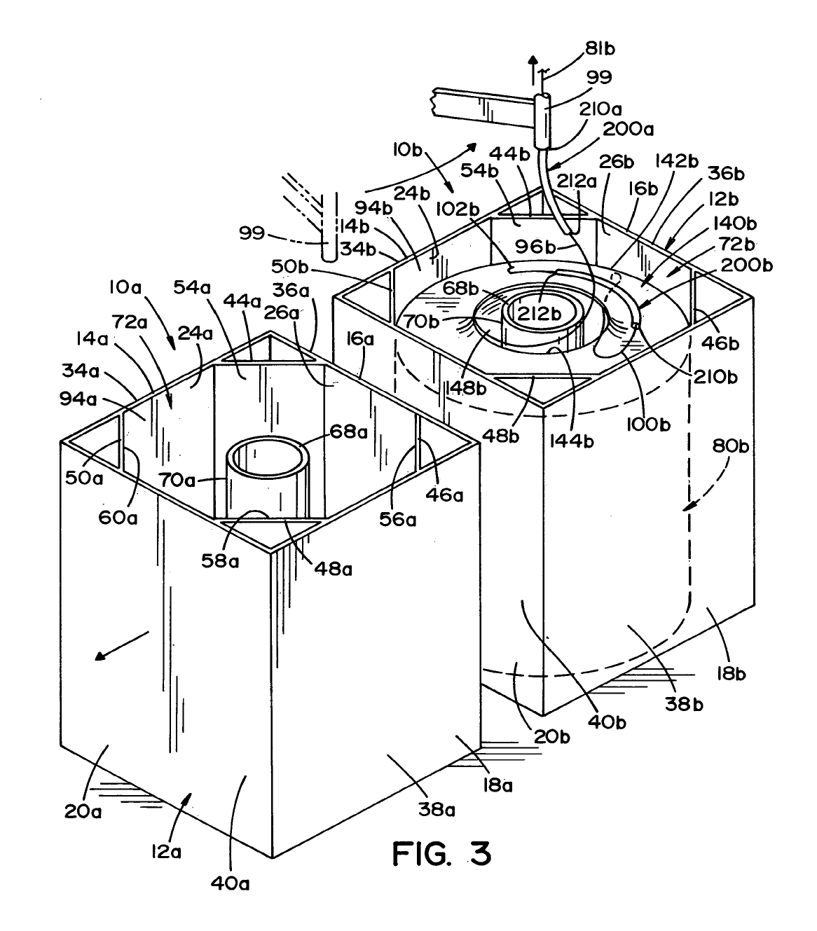

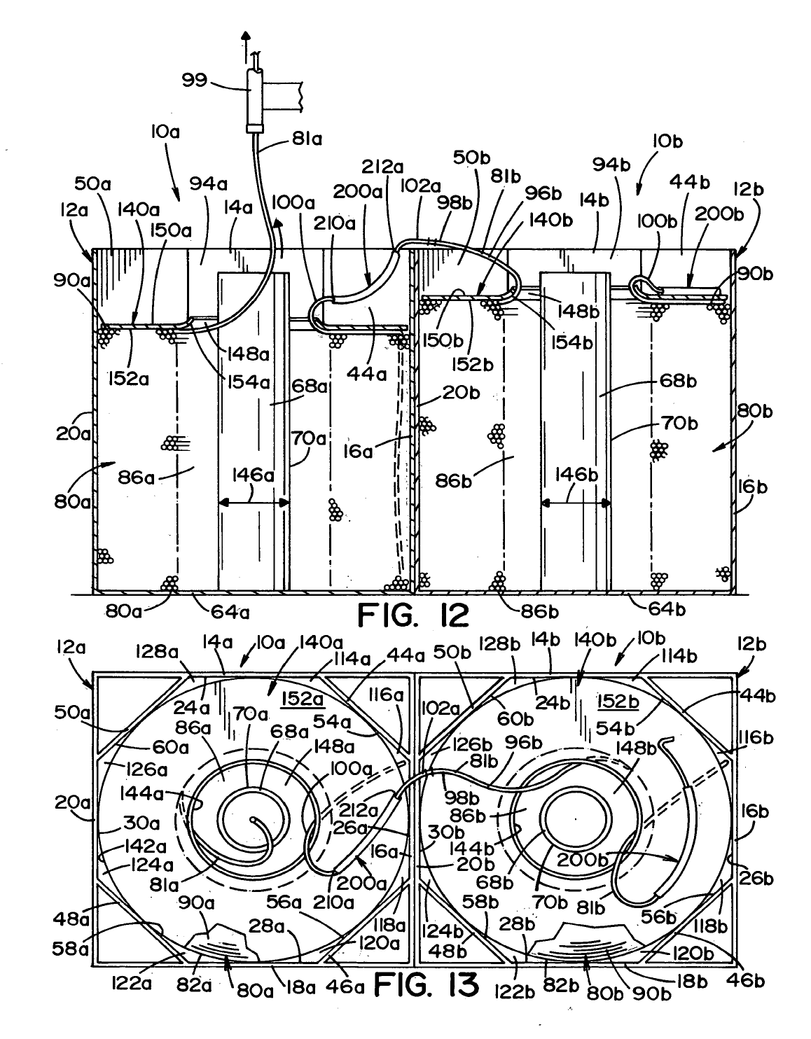

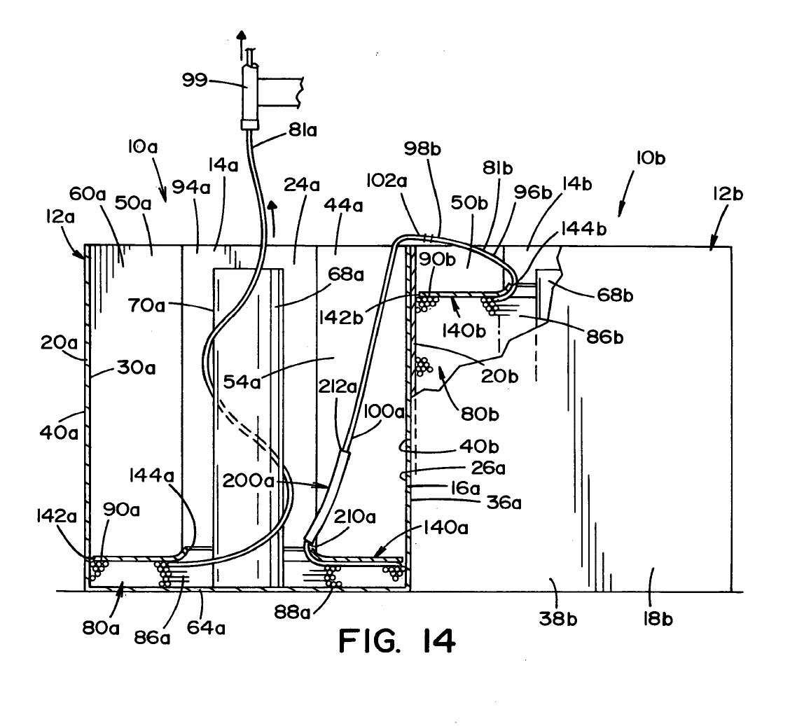

Referring now in greater detail to the drawing wherein the showings are for the purpose of illustrating preferred embodiments of the invention only, and not for the purpose of limiting the invention, FIGS. 1-3 and FIGS. 12-15 show containers 10a and 10b which are side-by-side one another in an uninterrupted flow arrangement. While square packaging designs are shown and discussed in this application, the invention of this application has much broader applications and can be used with a wide range of welding wire packages including, but not limited to, welding wire drums. Further, containers 10a and 10b are shown to be virtually identical containers. Again, the use of identical containers is also not a requirement for this application. For example, a drum style container could be used side-by-side with a box style container without detracting from the invention of this application.

Again, for the simplification of the disclosure, containers 10a and 10b are the same style container and, therefore, common reference numbers will be used for both containers and will be distinguished from each other with the reference letter “a” for package 10a and “b” for package 10b.” Again, this application is not to be limited to identical or even similar packaging configuration for the containers that are joined together for uninterrupted wire flow. Further, since both containers are the same, the below discussion concerning container 10a also applies to container 10b and no “a” or “b” designation will be provided unless necessary for clarity. In addition, and for simplification, a detailed discussion of package 10b is not provided since it is shown to be the same as container 10a.

Container 10a is the first in line of the two containers and includes an outer container or packaging 12, which as stated above, is a square container, having sides 14, 16, 18 and 20, with inner surfaces 24, 26, 28 and 30, respectively and outer surfaces 34, 36, 38 and 40. The container further includes corner supports 44, 46, 48 and 50 having inner surfaces 54, 56, 58 and 60, respectively. Container 10a further includes a closed bottom 64 which can, as with the other box components, be any known closed bottom in the art including, but not limited to, bottom flaps extending from the side walls. Container 10a can further include a base sheet 66 and an inner core 68 having a radially outwardly facing surface 70.

Inner surfaces 24, 26, 28 and 30 along with surfaces 54, 56, 58 and 60 form an outer extent of a wire receiving cavity 72. The inner extent of wire receiving cavity 72, in this particular box arrangement, is defined by surface 70 of core 68 and the bottom extent is defined by base sheet 66. A wire coil 80 is wound from a welding wire 81 into cavity 72 by any known means in the art including techniques designed to create the desired cant or natural cast. After the wire is wound into coil 80, it includes a radially outward surface 82 supported by surfaces 24, 54, 26, 56, 28, 58, 30 and 60. Coil 80 further includes a radially inward surface defining a cylindrical central and open section 86 in the wire coil. Essentially, coil 80 has an annular configuration extending from a bottom 88 resting on base sheet 66 to a top 90 near a top container opening 94.

Coil 80 further includes a first wire extension 96 extending between coil 80 near top 90 and a feeding end 98; and a second extension 100 extending from wire coil 80 from near coil bottom 88 to a transfer end 102. Feeding end can be fed through a wire guide 99 to a welding operation. Second extension 100 is positioned such that it extends from near bottom 88 across the bottom of the coil and then up radial outward surface 82 such that the second extension is positioned between radial outward surface 82 and one of surfaces 24, 54, 26, 56, 28, 58, 30 and 60. However, in connection with a square container configuration including the disclosed octagonal wire cavity, the second extension can extend upwardly through one of the gaps produced between the coil and the packaging. In this respect, container 10 further includes wire cavity gaps 114, 116, 118, 120, 122, 124, 126 and 128. Accordingly, second extension 100 can extend through one of these gaps including gap 116 as is shown in the drawings.

Container 10 can further include a braking or retainer ring 140 to help control the unwinding of the welding wire from the coil as the wire is fed to the welding operation. Retainer ring 140 is known in the art and is disclosed in Cooper U.S. Pat. No. 5,819,934. However, as can be appreciated, the invention of this application can be used in connection with any known braking ring beyond the ring shown in Cooper U.S. Pat. No. 5,819,934. Ring 140, as shown, includes an outer peripheral edge 142 and an inner edge 144. Outer peripheral edge 142 is sized and configured to allow the braking ring to freely descend within the wire cavity and to prevent convolutions of the welding wire from springing upwardly between the outer periphery and surfaces 24, 54, 26, 56, 28, 58, 30 and 60. As is known in the art, peripheral edge 142 can be circular or can include projecting lobes to increase the ability of the ring to prevent the unwanted upward springing of the welding wire. Inner edge 144 can be circular and can have a diameter “c” which is greater than a diameter 146 of core 68 to produce a wire feeding gap 148 between the inner edge of the ring and the inner core surface. The wire feeding gap will be discussed in greater detail below. Ring 140 can further include a top surface 150, a bottom surface 152 that can at least partially rest on coil top 90. Ring 140 can further include a wire guiding curved surface 154 to prevent unwanted damage to the welding wire as it passes through wire feeding gap 148 toward top opening 94.

Container 10 further includes a transfer sleeve 200 that can be positioned on second end 100 between the bottom of the coil and transfer end 102. As will be discussed in greater detail below, transfer sleeve 200 is designed and configured to be maintained above the braking ring and between the braking ring and transfer end 102. While sleeve 200 is shown to be packaged on the transfer end, it could be packaged on the feeding end without detracting from the invention of this application. As will be discussed in greater detail below, the sleeve can be at least moved to the transfer side of the arrangement during the unwinding of the welding wire.

Container 10a is joined to container 10b by first positioning the containers next to one another and then fusing transfer end 102a of container 10a to feeding end 98b of container 10b with sleeve 200a being positioned about on one of second extension 100a of container 10a and first wire extension 96b of container 10b thereby creating an endless length of wire between feeding end 98a and transfer end 102b. While transfer sleeve 200 can be positioned before the joining step, the inclusion of a separable release slot, which will be discussed in detail below, it can also be positioned' after the joining step. Transfer sleeve 200a, while the wire is being fed to the welding operation, is maintained between rings 140a and 140b while wire remains in both containers. As will be also discussed in greater detail below, once container 10a is exhausted, the welding wire in coil 80a will be exhausted and transfer sleeve 200a will then be lifted from wire cavity 72a and positioned between wire guide 99 and ring 140b.

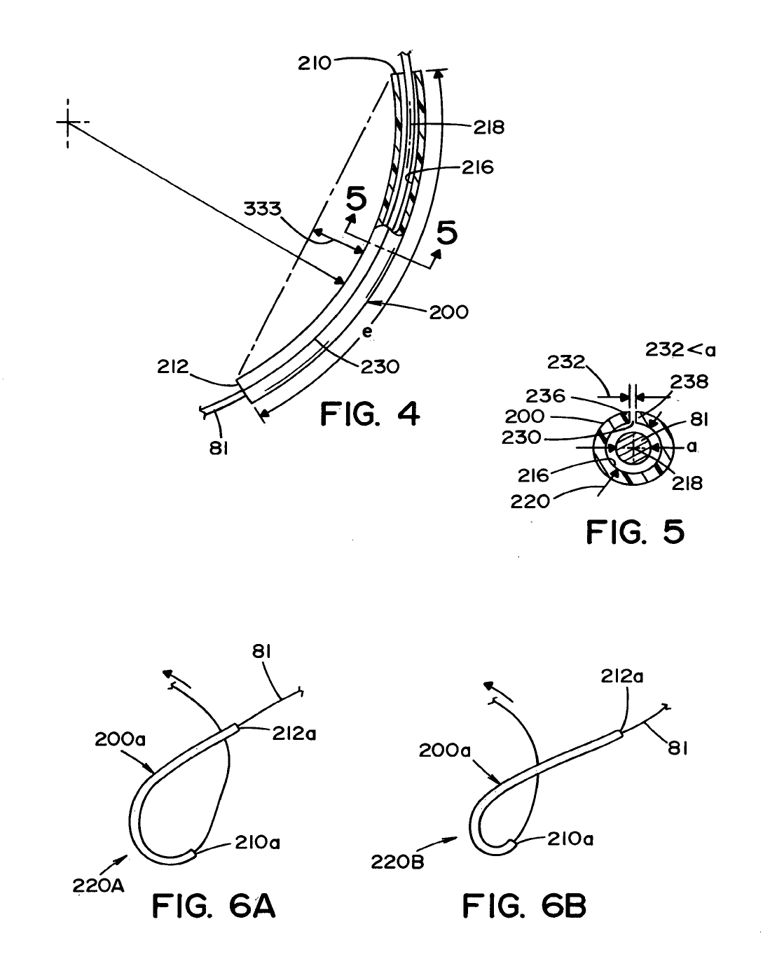

With reference to FIGS. 4-11 and 15A, sleeve 200 is elongated, extending from a first end 210 to a second end 212. Sleeve 200 includes a wire passage 216 extending between ends 210 and 212 and along a wire passage axis 218. Passage 216 can be cylindrical or can have other cross sectional configurations, however, passage 216 is shaped and sized to allow welding wire 81 to pass therethrough. As is shown, passage 218 has a diameter 220 that is greater than wire diameter “a” of wire 81. In one embodiment, diameter 220 is at least 0.050 inches greater than the wire diameter. In another embodiment, it is at least 100 inches greater. As a result, the welding wire is allowed to pass through sleeve 200 as it is drawn toward wire feeding implement 99.

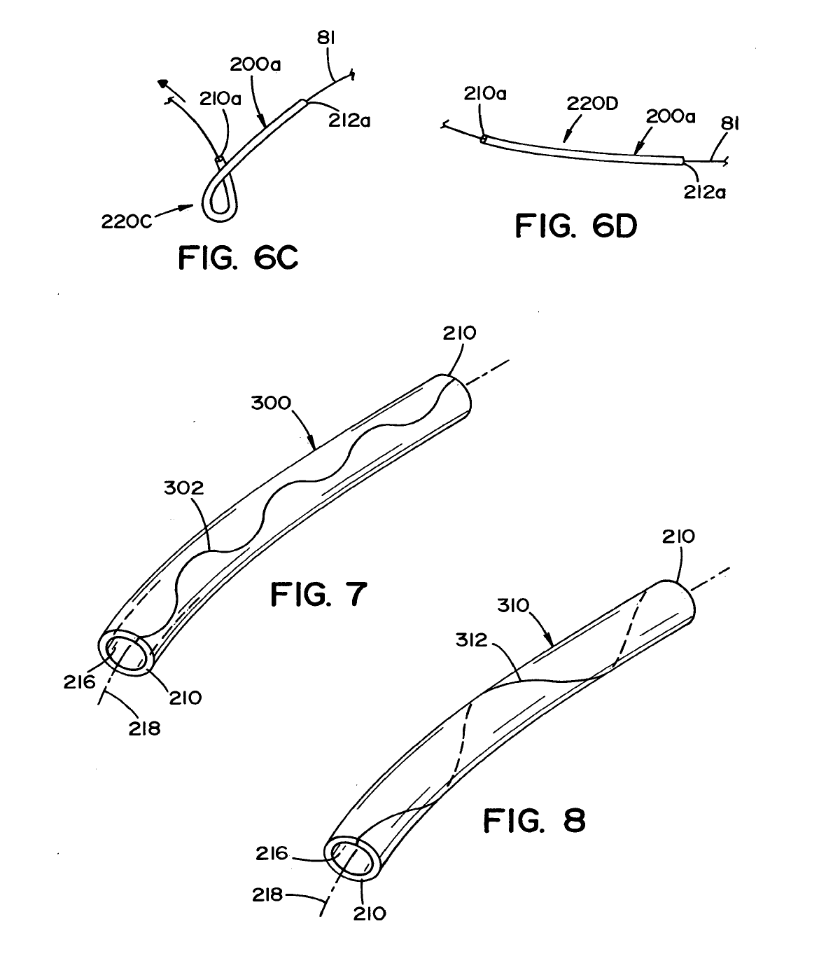

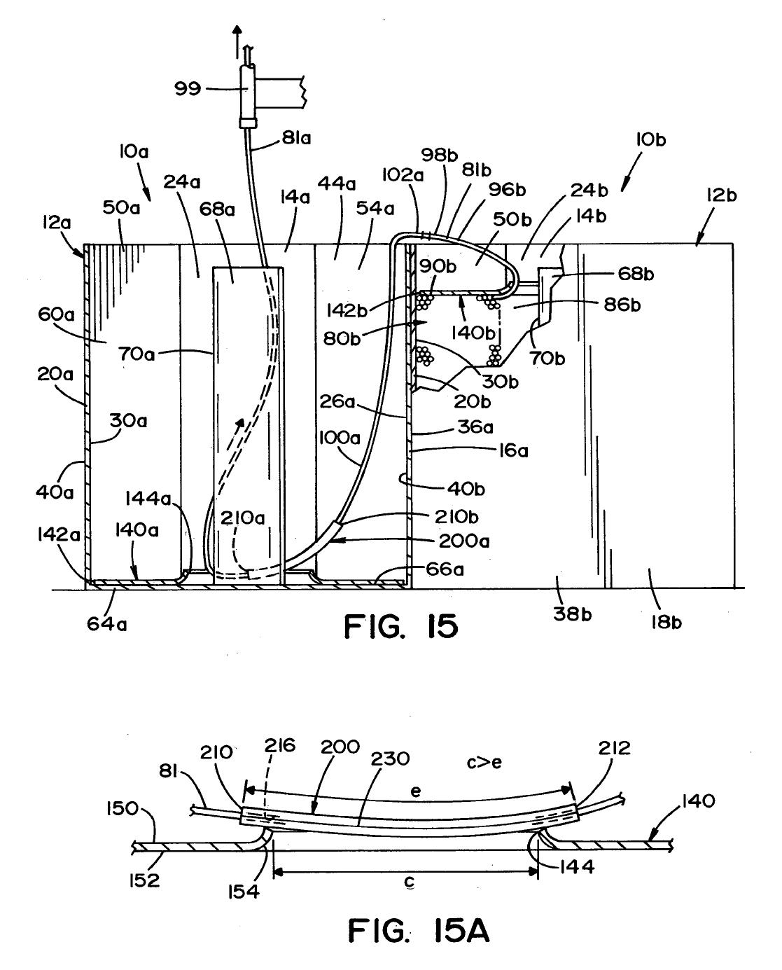

The function of sleeve 200 is to prevent or at least greatly reduce the formation of an e-script or tangle in the welding wire as the supply of welding wire is transferred from container 10a to container 10b. More particularly, as the wire is being consumed from container 10a, wire passes from coil 80a past brake ring 140a toward feeding implement 99. As can be appreciated, the removal of welding wire from coil 80a reduces the remaining coil within container 10a wherein coil top 90a descends within wire cavity 72a. Braking ring 140a follows this descent and continues to control the unwinding of welding wire 81 a from wire coil 80a. Sleeve 200a can also follow the descent of the coil top and the braking ring as the welding wire is removed from the container. As a result, at the point when the remaining wire is removed from underneath the braking ring, sleeve 200a is near the bottom of the packaging edge as shown in FIG. 15. As additional wire is consumed by the welding operation, the remaining loop of welding wire in container 10a, will rise from near the bottom of the container toward top opening 94a. This rise of the final loop or convolution of wire is the beginning of when the e-script can be formed. With special references to FIGS. 6a, 6b, 6c and 6d, as the final coil is removed from container 10a, sleeve 200a is positioned by its weight and the movement of the wire in a wire loop 220. In this respect, as the remaining wire is lifted from the bottom of the container the wire begins the formation of loop 220 and sleeve 200 becomes positioned in a loop 220a, as is shown in FIG. 6A. As more wire is drawn through sleeve 200, the remaining loop tightens to a loop 2208. As the more wire is consumed, the loop tightens to a loop 220c where typically the e-script would be formed. However, sleeve 200a prevents the wire from making its final twist to form the e-script and its generally cylindrical configuration allows rotation of the sleeve relative to the wire to allow the loop to be released into a straight section 220d. At this point, the wire has been completely exhausted from container 10a and is in the process of being unwound from container 10b. Sleeve 200a is then positioned between ring 140b and wire feeder implement 99.

The frictional engagement between sleeve passage 216 of sleeve 200 and the welding wire causes the sleeve to lift upwardly toward wire feeding implement 99 as wire 81 is being drawn toward implement 99. At this point, sleeve 200a has served its purpose while sleeve 200b can be utilized for a subsequent container of welding wire 10c (not shown). Therefore, it is advantageous that the sleeve be removable. Accordingly, sleeve 200 can include a separable release slot 230 extending between first and second ends 210 and 212, respectively.

Release slot 230 can be generally parallel with axis 218 and can include a release slot gap 232. In this respect, sleeve 200 can be a tubular component that can be formed by a planar sheet, extruded or manufactured by any known means in the art such that it has a single wall construction extending about axis 218 from a side edge 236 to a side edge 238 which can be spaced from one another to form slot gap 232. Further, sleeve 200 can be formed from multiple components without detracting from the invention of this application. Gap 232 can extend from first end 210 to second end 212 or can only partially extend between the two ends.

Gap 232 can be used to pry side edges 236 and 238 away from one another sufficiently to allow the length of welding wire approximately equal to length “e” of sleeve 200 in passage 216 to be transversely removed from the wire passage. In one embodiment, gap 232 is between 0.010 inches and 0.030 inches; however, the size is at least partially dependent on the wire diameter. In another embodiment, it is greater than 0.030 inches. As can be appreciated, the only way to remove sleeve 200 from a continuous wire, without cutting the wire or the sleeve, is to remove the wire transversely through slot 230.

Other slot configurations are shown in FIG. 7 and FIG. 8. More particularly, in another embodiment, a sleeve 300 is shown which includes a curvilinear slot 302 which can be configured similar to that of a sine wave. As can be appreciated, the wire traveling through sleeve 300 generally follows axis 218 as described above a curvilinear slot therefore requires a greater gap between the side edges to allow the welding wire to pass transversely out slot 302. As a result, it is less likely that the sleeve will inadvertently become disengaged from the welding wire during the feeding of the welding wire to the welding operation and during the transfer from container 10a to 10b.

FIG. 8 shows yet another sleeve 310 having a spiral slot 312 extending between first and second ends 210 and 212, respectively. As can be appreciated, the spiral configuration of slot 312 is less likely to allow the wire to inadvertently pass therethrough during the feeding and/or transferring of the welding wire. As a result, slots 302 and 312 can have larger gaps without adversely affecting the performance of the sleeve. This can result in the sleeve being easier to remove in that the side edges are easier to grasp and pull apart.

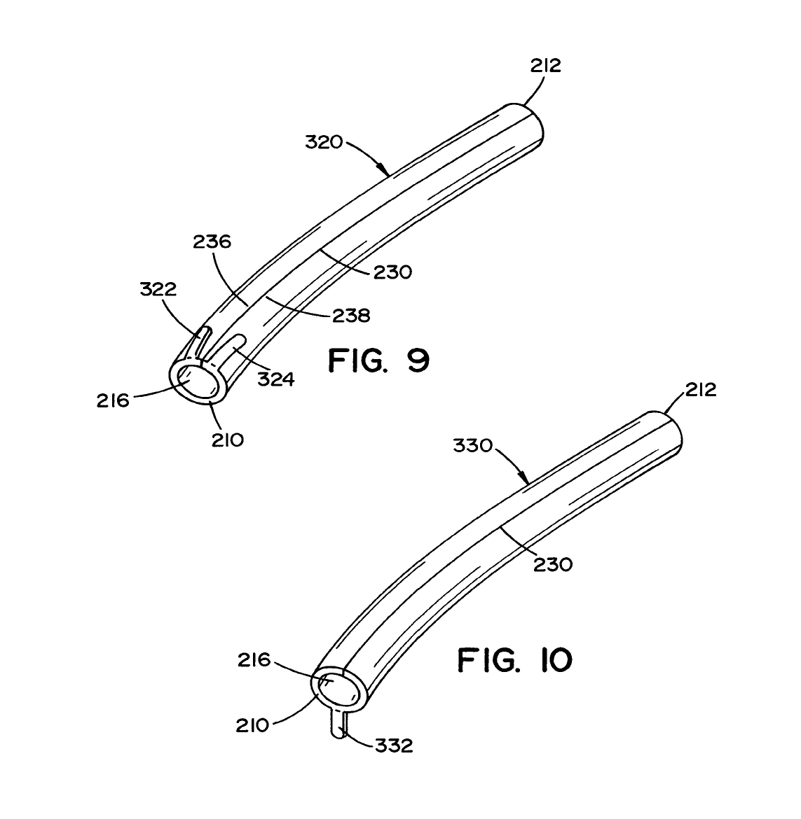

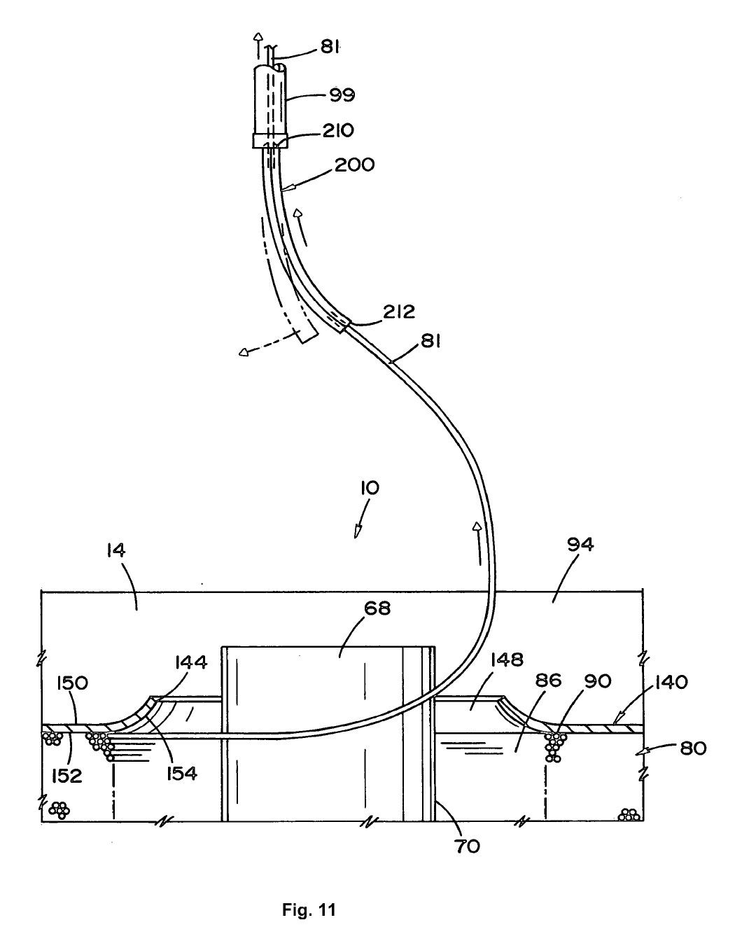

In order to further facilitate the removal of the sleeve from the continuous welding wire any of the sleeves can include finger tabs. More particularly, shown in FIG. 9 is a sleeve 320 that can include finger tabs 322 and 324 that can be used by the welding operator to separate side edges 236 and 238. As can be appreciated, especially when dealing with fine or small diameter welding wires, gap 232 may be a small gap to maintain the welding wire in the. passage and, therefore, the inclusion of finger tabs 322 and 324 reduce the tendency of the operator to use an implement to spread apart side edges. As can also be appreciated, using an implement to spread apart the side edges can damage the welding wire which can have adverse effects on the wire feeding and the welding operation. Finger tabs 322 and 324 can be positioned on either side of slot 230 or the other slots described above, wherein pulling the tabs away from one another will help separate the slots sufficiently to allow the welding wire to pass transversely through the slot.

With reference to FIG. 10, yet a further embodiment is shown. In this respect, shown is a sleeve 330 that includes a finger tab 332 circumferentially spaced from slot 230 with or without tabs 322 and 324 discussed above. This configuration allows the user or welding operator to merely pull the finger tab such that the sleeve is pulled away from the welding wire and the welding wire opens the slots to allow the sleeve to be removed from the welding wire. While tabs 322, 324 and 332 are shown near first end 210, the tabs can also be positioned near second end 212 and/or be positioned at both ends without departing from the invention of this application. Further, any combination of these tabs can be utilized on any of the sleeves discussed above to further help the operator remove the sleeve from the welding wire. Further, other slot configurations and sleeve configurations can be utilized without departing from the invention of this application.

In yet another embodiment, sleeve 200 can be an arcuate sleeve to further enhance its performance. In this respect, sleeve 200 can have a curve such that a cordal gap 333 is in the range of 0.050 inches to 0.150 inches or in the range of 0.150 inches to 1.00 inches. This arcuate configuration helps position the sleeve in loop 220 described above and helps orient the sleeve in the proper orientation to follow loop 220 through its progression from 220a, 220b, 220c and 220d. Essentially, the curved configuration is sufficient to cause the wire to engage the passage as it passes through the passage. Further, the arcuate configuration of sleeve 200 can be configured to match the curve in the welding wire in the second extension portion 100 of container 10 as the sleeve descends with the unwinding of the wire from the container. This curved configuration reduces the frictional engagement between the wire and the sleeve as the sleeve descends into the wire cavity. However, as the sleeve is raised upwardly and outwardly of container 10 and after loop 220 is straightened to section 220d, the curve configuration of sleeve 200 creates sufficient frictional engagement between the wire and the sleeve to raise the sleeve up toward feeding implement 99. Essentially, the frictional engagement between the sleeve and the welding wire at this point is greater than the weight of the sleeve to maintain the sleeve closely adjacent to implement 99. As can be appreciated, sleeve 200 is more accessible for removal when it is positioned near implement 99.

In yet another embodiment, sleeve 200 has a length “e” between ends 210 and 212 that is greater than diameter c of inner ring edge 144. Length “e,” in one embodiment, can be in the range 6 inches to 12 inches, or in the range 8 inches to 14 inches. This configuration reduces the likelihood that the trailing edge of the welding wire or sleeve will drop below the top side of the retainer ring. As can be appreciated, there is a greater risk of the sleeve become lodged in the container or a tangle forming if sleeve 200 is allowed to fall below the retainer ring.

In addition, while not discussed in detail, any of the embodiments of this invention can include other mechanisms known in the art such as hold-down mechanisms which are utilized to secure the wire coil during the transport of container 10a or 10b. Further, additional containers can be combined to this arrangement. Even, further, vapor barriers can also be used to help protect the welding wire from adverse environments such as during the transport of the container by ship across the ocean. Furthermore, other wire controlling mechanisms can be used to control the out flowing welding wire from the container beyond those discussed above. Accordingly, as is stated above, while only one packaging design was discussed in relation to the invention of this application, the invention of this application should not be limited to this configuration.

While considerable emphasis has been placed on the preferred embodiments of the invention illustrated and described herein, it will be appreciated that other embodiments and/or equivalents thereof can be made and that many changes can be made in the preferred embodiments without departing from the principals of the invention. Accordingly, it is to be distinctly understood that the foregoing descriptive matter is to be interpreted merely as illustrative of the invention and not as a limitation.

What is claimed:

1. A system for the uninterrupted flow of welding wire to an associated welding operation comprising:
a first container including an outer packaging having a closed bottom and at least one vertically extending side wall forming a coil receiving cavity and a top opening;
a first coil of welding wire, contained in the coil receiving cavity of the first container, having a top portion and a bottom portion including a first extension of the wire extending from the top portion to an associated welding operation through the top opening of the first container and a tail extension extending from the bottom portion of the coil;
a second container including an outer packaging having a closed bottom and at least one vertically extending side wall forming a coil receiving cavity and a top opening;
a second coil of welding wire, contained in the coil receiving cavity of the second container, having a top portion and a bottom portion including a second extension of wire extending from the top portion of the second coil and joined to the tail extension of the first coil and forming a transfer segment extending between the top opening of the first container and the top opening of the second container; and
a transfer sleeve having a first end and a second end, the transfer sleeve defining a wire passage extending along a sleeve axis, the wire passage is sized to allow the welding wire to travel axially through the passage, the transfer sleeve further including a separable release slot extending between the first end and the second end, the slot having substantially closed position to maintain the welding wire in the passage and a separated position to allow a length of wire in the passage to pass transversely through the slot,
wherein the transfer sleeve is on the transfer segment during the associated welding operation and follows the descent of the first coil toward the closed bottom of the first container while on the transfer segment and while wire is fed to the associated welding operation from the first coil.

2. The system as defined in claim 1, wherein the transfer sleeve is substantially cylindrical configuration and has a length less than the diameter of the wire coil.

3. The system as defined in claim 1, wherein the transfer sleeve is formed from a planar sheet extending about said sleeve axis.

4. The system as defined in claim 1, further including a braking ring for controlling the unwinding of said wire from said wire coil, said braking ring resting on said top portion of said coil and descending within said cavity during the unwinding of said wire from said first container, said braking ring being annular having an inner periphery, an outer periphery, a bottom surface extending between said inner and outer peripheries and a top, said bottom surface resting on said top portion of said coil, said inner periphery having a diameter and forming an inner opening, said second extension extending between said coil and said at least one vertically extending side wall and between said ring bottom and said top portion of said coil and out said inner opening, the transfer sleeve having a length between said first and second ends that is greater than said diameter and less than the diameter of the wire coil.

5. The system as defined in claim 1, wherein said sleeve axis and the transfer sleeve are arcuate.

6. The system as defined in claim 1, wherein said separable release slot is parallel to said sleeve axis.

7. The system as defined in claim 1, wherein said separable release slot has a width transverse to said sleeve axis and said width is less than the diameter of said wire.

8. The system as defined in claim 1, wherein said separable release slot is curved.

9. The system as defined in claim 1, wherein the separable release slot has a sinusoidal shape.

10. The system as defined in claim 1, wherein the transfer sleeve is formed from a planar sheet extending about said sleeve axis from a first longitudinal edge to a second longitudinal edge, said first and second longitudinal edges being circumferentially spaced from one another a distance less than a diameter of the wire.

11. The system as defined in claim 1, wherein the transfer sleeve further includes a welding wire gripper, said gripper frictionally engaging at least a portion of said length of said wire in said passage.

12. The system as defined in claim 11, wherein said welding wire gripper engages said at least said portion of said length of said wire in sliding surface friction.

13. The system as defined in claim 11, wherein said sleeve has a weight and wherein frictional engagement of said welding wire gripper with said wire produce a gripping force between said wire and the transfer sleeve, said gripping force being greater than said weight.

14. The system as defined in claim 11, wherein said welding wire gripper includes at least one tab.

15. The system as defined in claim 1, wherein said sleeve axis and the transfer sleeve are arcuate, said arcuate configuration producing a frictional engagement between said sleeve and said length of said wire.

16. The system as defined in claim 1, wherein said separable release slot is spiraled about said sleeve axis between the first and second ends of said transfer sleeve.
